(19) United States
(12) Patent Application Publication
(10) Pub. No.: US 2023/0136853 A1
(43) Pub. Date: May 4, 2023

(54) METHOD FOR MAINTAINING EQUIPMENT BY REMOTE OPERATION AND ASSISTANCE AND ELECTRONIC DEVICE

(71) Applicants: HONGFUJIN PRECISION ELECTRONICS (CHENGDU) Co., Ltd., Chengdu (CN); HON HAI PRECISION INDUSTRY CO., LTD., Chengdu (CN)

(72) Inventors: ZI-QING XIA, Chengdu (CN); DONG CHEN, Chengdu (CN); TAI-MIN LI, Chengdu (CN); JING PENG, Chengdu (CN); PEI-XIANG WANG, Chengdu (CN); JIAN-JUN LI, Chengdu (CN); NING XIE, Chengdu (CN); QIAN-YONG HAN, Chengdu (CN)

(21) Appl. No.: 17/844,924

(22) Filed: Jun. 21, 2022

(30) Foreign Application Priority Data
Oct. 29, 2021 (CN) 202111274278.4

(51) Int. Cl. G05B 23/02; G06K 7/14; G06F 16/953; G06T 11/60

(52) U.S. Cl. CPC G05B 23/0275; G06K 7/1417; G06F 16/953; G06T 11/60

(57) ABSTRACT

A method for maintaining equipment by remote operation and assistance, applied in an electronic device, obtains on-site information in response to a failure notification, and queries maintenance guidance information according to the on-site information. When the maintenance guidance information exists, the electronic device displays or plays the maintenance guidance information by Augmented Reality (AR) glasses, collects user operation data of a maintenance operation in real time, compares the user operation data with the maintenance guidance information, and prompts a user to correct a maintenance operation when a comparison indicates that a current repair or maintenance operation is erroneous. When the maintenance guidance information does not exist, the electronic device establishes a connection with a remote expert terminal by the AR glasses, and obtains real-time guidance from the remote expert terminal.

This application claims priority to Chinese Patent Application No. 202111274278.4 filed on Oct. 29, 2021, the contents of which are incorporated by reference herein.

### FIELD

The subject matter herein generally relates to an industrial maintenance field, in particular, relates to a method for maintaining equipment by remote operation and assistance and an electronic device.

### BACKGROUND

Maintenance works on different equipment become more complex as the equipment becomes more complex. After a placement machine fails, senior engineers are required to perform maintenance, and perhaps experts and manufacturers are required to provide assistance. Maintenance skills of on-site maintenance personnel are uneven, and maintenance efficiency is low, the equipment utilization rate is affected. Sparse experts, high cost of technical assistance, long training cycle for new recruits, and lack of experience will lead to problems such as low maintenance efficiency, heavy time-consumption and labor-intensive work, with poor safety.

Furthermore, traditional training methods are not efficient, and enterprises often need to spend a lot of training time and expenses. Learners cannot be productive right away, thus consuming the time and energy of teaching staff. At present, although there are a few application softwares in the field of industrial maintenance that can provide auxiliary maintenance functions, the maintenance needs of specific equipment such as placement machines are not met, nor can it meet the maintenance needs of specific faults. In addition, most of these softwares need to be connected to the Internet to run, and for some enterprises with high security and confidentiality requirements, the maintenance site is not connected to an external network.

### BRIEF DESCRIPTION OF THE DRAWINGS

Implementations of the present disclosure will now be described, by way of embodiment, with reference to the attached figures.

FIG. 1 is an application architecture diagram of a method for maintaining equipment by remote operation and assistance.

FIG. 2 is a flowchart of one embodiment of the method for maintaining equipment by remote operation and assistance.

FIG. 3 is a schematic diagram of on-site information being collected.

FIG. 4 is a schematic diagram of a maintenance guidance sub-module.

FIG. 5 is a schematic diagram of an interaction between terminal equipment and remote expert terminal, and cloud server.

FIG. 6 is a schematic diagram of one embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

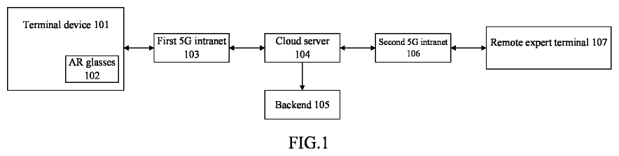

FIG. 1 illustrates an application architecture of a method for maintaining equipment by remote operation and assistance. The method is applied in a terminal device 101, a cloud server 104, and a remote expert terminal 107. The terminal device 101 is used by the user to collect on-site information. The terminal device 101 at least includes Augmented Reality (AR) glasses 102. The terminal device 101 collects the on-site information by using the AR glasses 102. The terminal device 101 transmits the on-site information to the cloud server 104 by a first 5G intranet 103. The cloud server 104 stores 3D model data, maintenance guidance information, expert cases, historical maintenance records, and on-site information of the device. The backend 105 is used to manage the maintenance guidance information, the expert cases and the on-site information. The remote expert terminal 107 obtains the on-site information from the cloud server 104 by a second 5G intranet 106.

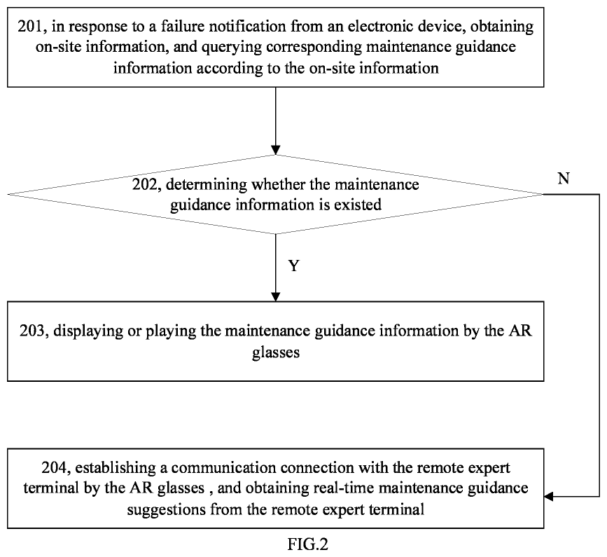

FIG. 2 illustrates the method for maintaining equipment by remote operation and assistance. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

At block 201, in response to a failure notification from an electronic device, obtaining on-site information, and querying corresponding maintenance guidance information according to the on-site information.

In one embodiment, the method is applied to electronic equipment, and the electronic equipment includes, but is not limited to, a mounter machine. When the electronic equipment fails, for example, the mounter machine cannot apply a software patch or an update as a solution, or the placement machine cannot accurately patch components to corresponding position, defective products are produced. When personnel on a production line find the above fault in the mounter machine, a failure notification is issued to notify the maintenance personnel to go to repair the faulty equipment.

In one embodiment, when the electronic device fails, the electronic device generates a failure notification. Exemplarily, when the electronic device cannot be patched correctly, a patch error fault prompt will be displayed on a display screen of the electronic device.

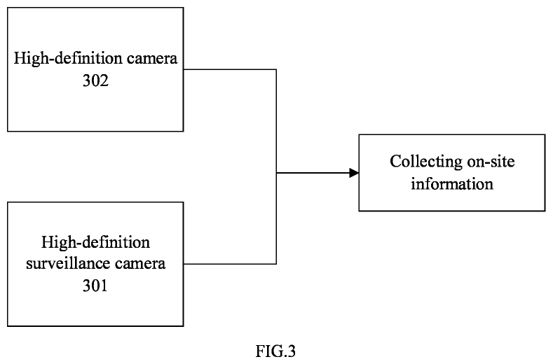

FIG. 3 illustrates collecting on-site information. In one embodiment, obtaining the on-site information includes: collecting on-site maintenance video of a faulty equipment by the high-definition surveillance camera 301 inside the faulty equipment, and collecting real-time video or picture of the faulty equipment by a high-definition camera 302 on the AR glasses 102. The high-definition surveillance camera 301 collects maintenance videos of users, and is used to determine surrounding environment video when the faulty equipment is being repaired. The high-definition camera 302 on the AR glasses 102 collects the real-time video or the pictures of the faulty equipment, which helps the user to further determine a location of a fault on the faulty equipment, or to provide real-time maintenance guidance and suggestions for the remote expert terminal 107.

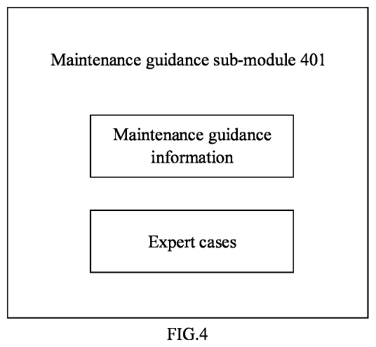

In one embodiment, the backend 105 includes a maintenance guidance sub-module 401. FIG. 4 illustrates the maintenance guidance sub-module. The maintenance guidance sub-module 401 is used to store and manage maintenance guidance information and expert cases. In one embodiment, the maintenance guidance information includes an operation video and operation instructions for completing a maintenance process for the fault of the faulty equipment. In one embodiment, the maintenance process and expert cases are displayed by a 3D model, so that the user can quickly understand how to perform maintenance. The 3D model data is stored in the cloud server 104.

In one embodiment, the remote expert terminal 107 manages the maintenance guidance information by the backend 105 of the cloud server 104. In one embodiment, the remote expert terminal 107 supplements or adds the original maintenance guidance information.

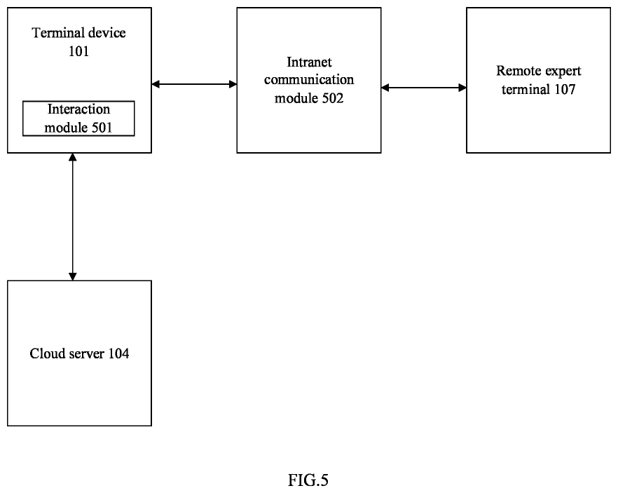

FIG. 5 illustrates an interaction between terminal equipment and remote expert terminal, and cloud server. In one embodiment, the terminal device 101 scans a two-dimensional code of the faulty equipment by the AR glasses 102 and communicates with the cloud server 104 by the interaction module 501, and obtains historical maintenance information of the faulty equipment from the cloud server 104. In one embodiment, the terminal device 101 transmits the on-site information to the cloud server 104, and retrieves corresponding maintenance guidance information from the cloud server 104. In one embodiment, the terminal device 101 communicates with the remote expert terminal 107 by an intranet communication module 502. The intranet communication module 502 includes the first 5G intranet 103 and the second 5G intranet 106.

In one embodiment, the terminal device 101 scans the two-dimensional code of the faulty equipment by the AR glasses 102, obtains the historical maintenance information of the faulty equipment from the cloud server 104, and determines the maintenance guidance information from the historical maintenance information according to selection by user. In one embodiment, the historical maintenance information includes maintenance records of the faulty equipment and maintenance instruction information of the maintenance records. When the historical maintenance information of the faulty equipment is acquired, user determines keywords according to the location where the electronic device has failed, and inputs the keywords into a search box of the AR glasses 102 to search for the corresponding historical maintenance information. When the corresponding historical maintenance information cannot be found, the terminal device 101 returns to the search box and continues to search by the search box. For example, for an operation failure of the mounter machine, the user determines keywords such as “power failure”, and enters the keywords into the search box of the AR glasses 102 to make a search. When finding the corresponding historical maintenance information, the terminal device 101 retrieves the maintenance guidance information corresponding to the historical maintenance information, and assists the user in repairing the faulty equipment.

In one embodiment, the terminal device 101 scans the two-dimensional code of the faulty equipment by the AR glasses 102, obtains the historical maintenance information of the faulty equipment from the cloud server 104, and matches the on-site information with the historical maintenance information, and determines that the historical maintenance information matching the on-site information is the maintenance instruction information. When the historical maintenance information of the faulty equipment is obtained, the terminal device 101 matches the real-time video or picture of the faulty equipment collected by the AR glasses 102 with the historical maintenance information picture or video of the AR glasses 102, and determines the historical maintenance information matching with the real-time video or picture of the faulty equipment, and the real-time video or picture of the faulty equipment is collected by the AR glasses 102. For example, by parsing the real-time videos of the faulty equipment collected by the AR glasses 102, the terminal device 101 intercepts the real-time videos to obtain key video parts, inputs the key video parts into the matching box, and obtains the historical maintenance information matching with the real-time video of the faulty equipment, and takes the historical maintenance information matching with the real-time video of the faulty equipment as the maintenance guidance information.

At block 202, determining whether the maintenance guidance information is existed.

In one embodiment, when the keyword is entered into the search box, if the corresponding historical maintenance information can be obtained, it is determined that the maintenance guidance information exists. If the corresponding maintenance guidance information is not obtained, it is determined that the maintenance guidance information does not exist.

In one embodiment, if the historical maintenance information of the faulty equipment contains historical maintenance information that matches the real-time video of the faulty equipment collected by the AR glasses 102, it is determined that maintenance guidance information exists. If the historical maintenance information of the faulty equipment does not match the faulty equipment collected by the AR glasses 102, the real-time video not matching the historical maintenance information will determine that the maintenance guidance information does not exist.

At block 203, when the maintenance guidance information exists, displaying or playing the maintenance guidance information by the AR glasses 102.

In one embodiment, when the maintenance guidance information is existing, the terminal device 101 calls up the maintenance guidance information from the cloud server 104 by the AR glasses 102, displays or plays the content of the maintenance guidance information, and enables repair of the faulty equipment. In one embodiment, the maintenance guidance information is displayed on the AR glasses 102, so that dedicated/experienced users can be tasked to repair the faulty equipment and improve maintenance efficiency.

In one embodiment, when the user repairs the faulty equipment according to the maintenance guidance information, the AR glasses 102 synchronously collects and records user operation data of an maintenance operation in real time, tracks user operation data and compares the user operation data with the maintenance guidance information. For example, by comparing multiple images of point of fault of the faulty equipment within a preset time, or multiple frames of images captured from the video and images of the parts, with the parts of the fault point included in the maintenance guidance information in a non-fault state of the faulty equipment, this determines whether the operation data is abnormal. If the tracking data compared to the maintenance guidance information is abnormal, a warning message will be output to remind the user that there is an error in the maintenance operation, or in a maintenance procedure or a maintenance method, and that the error should be corrected in time. For example, the electronic equipment cannot attract the iron sheet, resulting in the product not being affixed with the corresponding iron sheet. The user may obtain the solution according to the maintenance guidance information as being that a nozzle of the electronic equipment needs to be replaced. When the user replaces the nozzle according to the maintenance guidance information and the replaced nozzle is inconsistent with the nozzle model properly used by the electronic equipment, the warning message will be output to remind the user that there is an error in the maintenance operation, and check whether the maintenance operation is correct until the user replaces the nozzle with a nozzle properly used in the electronic equipment, than the maintenance procedure is completed.

At block 204, when the maintenance guidance information does not exist, establishing a communication connection with the remote expert terminal 107 by the AR glasses 102, and obtaining real-time maintenance guidance suggestions from the remote expert terminal 107.

In one embodiment, when the maintenance guidance information does not exist, the user cannot carry out maintenance of the faulty equipment, the terminal device 101 establishes a communication connection with the remote expert terminal 107 by the AR glasses 102. Further, the AR glasses 102 transmits the collected on-site information by the first 5G intranet 103 to the cloud server 104 to save the on-site information and the remote expert terminal 107 can obtain the on-site information from the cloud server 104. After the terminal device 101 establishes a communication connection with the remote expert terminal 107, the remote expert terminal 107 calls the on-site information from the cloud server 104 by the second 5G intranet 106, communicates with the user according to the on-site information, and gives maintenance guidance suggestions.

In one embodiment, the AR glasses 102 establish a network connection with the remote expert terminal 107 by the 5G intranet. The user of the AR glasses 102 initiates a video call with a remote expert of the remote expert terminal 107 by the AR glasses 102. When the remote expert receives the video call, a video conference call room is established. In the video conference call room, the user or the remote expert can invite other users or other remote experts to join. When the user who originally initiated the video call chooses to end the video call, the video conference call room will be dismissed, and all the invited remote experts or other users will exit the video conference call room.

In one embodiment, all 5G intranets use adaptive transmission mode to transmit the on-site information. The adaptive transmission mode can dynamically adjust the definition of the video in the on-site information according to the bandwidth of the 5G intranet, preventing the remote expert terminal 107 from being stuck or hanging when viewing the real-time video or picture of the faulty equipment.

In one embodiment, the call records generated after the AR glasses 102 are used to establish the communication connection with the remote expert terminal 107 are saved to the cloud server 104 and managed by the backend 105 of the cloud server 104, including: saving valuable call records and the on-site information, saving valuable call records and on-site information, and deleting worthless call records and on-site information. In one embodiment, the valuable call records or the on-site information include, but are not limited to, significant reference and information on parts of the electronic equipment that frequently fails. Worthless call records or on-site information include, but are not limited to, no significant reference being found and information which is irrelevant.

The above are only specific embodiments of the present application, but are not to limit the protection scope of the present application. For those of ordinary skill in the art, improvements can be made without departing from the inventive concept of the present application, but these all belong to the protection scope of the present application.

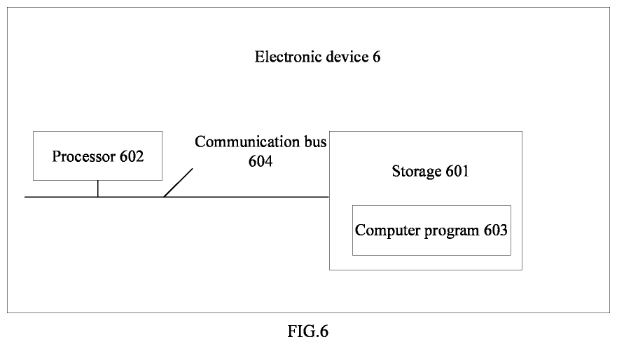

FIG. 6 illustrates the electronic device. The electronic device 6 includes a storage 601, at least one processor 602, and a computer program 603 stored in the storage 601 and executed by the processor 602, and at least one communication bus 604.

Those skilled in the art can understand that the schematic diagram shown in FIG. 6 is only an example of the electronic device 6, and does not constitute a limitation on the electronic device 6. Other examples may include more or less components than those shown in the drawings, or have different combinations thereof, or different components, for example, the electronic device 6 may also include input and output devices, network access devices, and the like.

The at least one processor 602 may be a Central Processing Unit (CPU), and may also be a general-purpose processor, a Digital Signal Processors (DSP), an Application Specific Integrated Circuit (ASIC), a Field-Programmable Gate Array (FPGA) or other programmable logic devices, discrete gate or transistor logic devices, discrete hardware components, etc. The at least one processor 602 can be a microprocessor or the at least one processor 602 can also be any conventional processor, etc. The at least one processor 602 is the control center of the electronic device 6, using various interfaces and lines to connect various parts of the entire electronic device 6.

The storage 601 can be used to store the computer program 603, and the at least one processor 602 implements the electronic program by executing the computer program 603 stored in the storage 601 and calling up the data stored in the storage 601. The storage 601 may mainly include a stored program area and a stored data area, wherein the stored program area may store an operating system, and at least one application program required for at least one function (such as a sound playback function, an image playback function, etc.), etc. The storage data area may store data (such as audio data) created in the use of the electronic device 6, etc. In addition, the storage 601 may include non-volatile storage such as a hard disk, an internal memory, a plug-in hard disk, a Smart Media Card (SMC), a Secure Digital (SD) card, a Flash Card (Flash Card), at least one disk storage device, flash memory device, or other non-volatile solid state storage device.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method for maintaining equipment by remote operation and assistance comprising:
in response to a failure notification, obtaining on-site information, and querying corresponding maintenance guidance information according to the on-site information;
when the maintenance guidance information exists, displaying or playing the maintenance guidance information by an Augmented Reality (AR) glasses, collecting user operation data of a maintenance operation in real time, comparing the user operation data with the maintenance guidance information, and outputting an warning message to prompt a user to correct the maintenance operation when a comparison result indicates that the operation is wrong;
when the maintenance guidance information does not exist, establishing a communication connection with a remote expert terminal by the AR glasses, and obtaining real-time maintenance guidance suggestions from the remote expert terminal.

2. The method for maintaining equipment by remote operation and assistance as recited in claim 1, further comprising:
scanning a two-dimensional code of a faulty equipment by the AR glasses, obtaining historical maintenance information of the faulty equipment from a cloud server, and determining the maintenance guidance information from the historical maintenance information according to user's selection operation; or
scanning the two-dimensional code of the faulty equipment by the AR glasses, obtaining the historical maintenance information of the faulty equipment from the cloud server, matching the on-site information with the historical maintenance information, and determining the on-site information matched with the historical maintenance information as the maintenance guidance information.

3. The method for maintaining equipment by remote operation and assistance as recited in claim 1, wherein the on-site information comprises the real-time video or picture of the faulty equipment collected by the AR glasses, on-site video of the maintenance operation collected by a surveillance camera.

4. The method for maintaining equipment by remote operation and assistance as recited in claim 2, wherein the historical maintenance information comprises maintenance records of the faulty equipment and maintenance guidance information of the maintenance records.

5. The method for maintaining equipment by remote operation and assistance as recited in claim 1, further comprising:
when the maintenance guidance information does not exist, transmitting the on-site information to the cloud server;
obtaining the on-site information from the cloud server by the remote expert terminal;
determining real-time maintenance guidance suggestions according to the on-site information by the remote expert terminal, and sending the real-time maintenance guidance suggestions to the cloud server;
sending the real-time maintenance guidance suggestion to the AR glasses by the cloud server.

6. The method for maintaining equipment by remote operation and assistance as recited in claim 5, further comprising:
transmitting the on-site information by a first 5G intranet by using an adaptive transmission mode, and the adaptive transmission mode dynamically adjusting clarity of the on-site information according to a bandwidth of the first 5G intranet.

7. The method for maintaining equipment by remote operation and assistance as recited in claim 5, further comprising:
obtaining the on-site information from the cloud server by a second 5G intranet by using an adaptive transmission mode, the adaptive transmission mode dynamically adjusting a clarity of the on-site information according to a bandwidth of the second 5G intranet.

8. The method for maintaining equipment by remote operation and assistance as recited in claim 5, further comprising:
outputting the real-time maintenance guidance suggestions by the AR glasses to guide the user to maintain the faulty equipment, recording a maintenance process of the faulty equipment, and saving the maintenance records of the faulty equipment and the real-time maintenance guidance suggestions to the cloud server.

9. An electronic device comprising:
a processor; and
a non-transitory storage medium coupled to the processor and configured to store a plurality of instructions, which cause the processor to:
in response to a failure notification, obtain on-site information, and query corresponding maintenance guidance information according to the on-site information;
when the maintenance guidance information exists, display or play the maintenance guidance information by an Augmented Reality (AR) glasses, collect user operation data of a maintenance operation in real time, compare the user operation data with the maintenance guidance information, and output an warning message to prompt a user to correct the maintenance operation when a comparison result indicates that the operation is wrong;
when the maintenance guidance information does not exist, establish a communication connection with a remote expert terminal by the AR glasses, and obtain real-time maintenance guidance suggestions from the remote expert terminal.

10. The electronic device according to claim 9, wherein the plurality of instructions are further configured to cause the processor to:
scan a two-dimensional code of a faulty equipment by the AR glasses, obtain historical maintenance information of the faulty equipment from a cloud server, and determine the maintenance guidance information from the historical maintenance information according to user's selection operation; or
scan the two-dimensional code of the faulty equipment by the AR glasses, obtain the historical maintenance information of the faulty equipment from the cloud server, match the on-site information with the historical maintenance information, and determine the on-site information matched with the historical maintenance information as the maintenance guidance information.

11. The electronic device according to claim 9, wherein the on-site information comprises the real-time video or picture of the faulty equipment collected by the AR glasses, on-site video of the maintenance operation collected by a surveillance camera.

12. The electronic device according to claim 10, wherein the historical maintenance information comprises maintenance records of the faulty equipment and maintenance guidance information of the maintenance records.

13. The electronic device according to claim 9, wherein the plurality of instructions are further configured to cause the processor to:
when the maintenance guidance information does not exist, transmit the on-site information to the cloud server;
obtain the on-site information from the cloud server by the remote expert terminal;
determine real-time maintenance guidance suggestions according to the on-site information by the remote expert terminal, and send the real-time maintenance guidance suggestions to the cloud server;
send the real-time maintenance guidance suggestion to the AR glasses by the cloud server.

14. The electronic device according to claim 13, wherein the plurality of instructions are further configured to cause the processor to:
transmit the on-site information by a first 5G intranet by using an adaptive transmission mode, and the adaptive transmission mode dynamically adjusting clarity of the on-site information according to a bandwidth of the first 5G intranet.

15. The electronic device according to claim 13, wherein the plurality of instructions are further configured to cause the processor to:
obtain the on-site information from the cloud server by a second 5G intranet by using an adaptive transmission mode, the adaptive transmission mode dynamically adjusting a clarity of the on-site information according to a bandwidth of the second 5G intranet.

16. The electronic device according to claim 13, wherein the plurality of instructions are further configured to cause the processor to:
output the real-time maintenance guidance suggestions by the AR glasses to guide the user to maintain the faulty equipment, record a maintenance process of the faulty equipment, and save the maintenance records of the faulty equipment and the real-time maintenance guidance suggestions to the cloud server.

17. A non-transitory storage medium having stored thereon instructions that, when executed by at least one processor of an electronic device, causes the least one processor to execute instructions of a method for maintaining equipment by remote operation and assistance, the method comprising:
in response to a failure notification, obtaining on-site information, and querying corresponding maintenance guidance information according to the on-site information;
when the maintenance guidance information exists, displaying or playing the maintenance guidance information by an Augmented Reality (AR) glasses, collecting user operation data of a maintenance operation in real time, comparing the user operation data with the maintenance guidance information, and outputting an warning message to prompt a user to correct the maintenance operation when a comparison result indicates that the operation is wrong;
when the maintenance guidance information does not exist, establishing a communication connection with a remote expert terminal by the AR glasses, and obtaining real-time maintenance guidance suggestions from the remote expert terminal.

18. The non-transitory storage medium as recited in claim 17, wherein the method comprising:
scanning a two-dimensional code of a faulty equipment by the AR glasses, obtaining historical maintenance information of the faulty equipment from a cloud server, and determining the maintenance guidance information from the historical maintenance information according to user's selection operation; or
scanning the two-dimensional code of the faulty equipment by the AR glasses, obtaining the historical maintenance information of the faulty equipment from the cloud server, matching the on-site information with the historical maintenance information, and determining the on-site information matched with the historical maintenance information as the maintenance guidance information.

19. The non-transitory storage medium as recited in claim 17, wherein the method comprising:
when the maintenance guidance information does not exist, transmitting the on-site information to the cloud server;
obtaining the on-site information from the cloud server by the remote expert terminal;
determining real-time maintenance guidance suggestions according to the on-site information by the remote expert terminal, and sending the real-time maintenance guidance suggestions to the cloud server;
sending the real-time maintenance guidance suggestion to the AR glasses by the cloud server.

20. The non-transitory storage medium as recited in claim 19, wherein the method comprising:
transmitting the on-site information by a first 5G intranet by using an adaptive transmission mode, and the adaptive transmission mode dynamically adjusting clarity of the on-site information according to a bandwidth of the first 5G intranet.
